(19) United States
(12) Patent Application Publication
(10) Pub. No.: US 2026/0037741 A1
(43) Pub. Date: Feb. 5, 2026

(54) ENHANCEMENT OF COMMUNICATION EXPERIENCE THROUGH UTILIZATION OF AI AGENT

(71) Applicant: Samsung Electronics Co., Ltd., Suwon-si (KR)

(72) Inventors: Anthony James Mars, Park Ridge, NJ (US); Rachel Rose Miller, Millbrook, NY (US); Misael Rodriguez Valenzuela, Brooklyn, NY (US); Myoung Woo Nam, Yongin-si (KR); Yeun-Wook Lim, Daegu (KR)

(21) Appl. No.: 19/173,609

(22) Filed: Apr. 8, 2025

Related U.S. Application Data
(60) Provisional application No. 63/678,207, filed on Aug. 1, 2024.

(51) Int. Cl. G06F 40/35; G06F 16/383

(52) U.S. Cl. CPC G06F 40/35; G06F 16/383

(57) ABSTRACT

A method includes obtaining, using a first AI agent, text from a text communication application. The method includes receiving an input selecting a presentation mode for the first AI agent, presenting, by the electronic device in the text communication application, a user interface (UI) of the first AI agent according to the selected presentation mode, the UI of the first AI agent identifying one or more suggested conversation inputs predictively generated by the first AI agent from the obtained text for possible inclusion in a text conversation, receiving, through the UI of the first AI agent, a selection of at least one of the one or more suggested conversation inputs, and providing, by the electronic device, a textual response incorporating the at least one selected suggested conversation input. The selected presentation mode for the first AI agent comprises one of multiple presentation modes.

### CROSS-REFERENCE TO RELATED APPLICATIONS AND PRIORITY CLAIM

This application claims priority under 35 U.S.C. § 119 (e) to U.S. Provisional Patent Application No. 63/678,207 filed Aug. 1, 2024. This provisional patent application is hereby incorporated by reference in its entirety.

### TECHNICAL FIELD

This disclosure relates generally to machine learning and user interfaces and, more specifically, to the use of artificial intelligence to extend the functionality of smartphones and other networked devices as communication platforms.

### BACKGROUND

The proliferation of artificial intelligence (AI) models as tools for intelligent sorting and searching of data, as well as for the generation of media, presents a host of opportunities for extending the functionality of electronic devices. To date, the possibilities of AI-based tools have principally been explored in the contexts of improvements in search and indexing, and of generative text creation, with enhancing the functionality of electronic devices as platforms for communication or collaboration, or for improving user interfaces remaining unconsidered areas for further development.

Accordingly, harnessing AI to enhance the functionality of portable, networked electronic devices as platforms for communication and collaboration remains a source of technical challenges and opportunities for improvement in the art.

### SUMMARY

This disclosure relates to systems and method to improve the quality of a communication experience through the utilization of multiple, temporary, shared, hidden and personalized artificial intelligence (AI) agents in text message communications.

In a first embodiment, a method includes obtaining, using a first artificial intelligence (AI) agent executed by an electronic device, text from a text communication application. The method further includes receiving, at the electronic device, an input selecting a presentation mode for the first AI agent, presenting, by the electronic device in the text communication application, a user interface (UI) of the first AI agent according to the selected presentation mode, the UI of the first AI agent identifying one or more suggested conversation inputs predictively generated by the first AI agent from the obtained text for possible inclusion in a text conversation, receiving, through the UI of the first AI agent, a selection of at least one of the one or more suggested conversation inputs, and providing, by the electronic device, a textual response incorporating the at least one selected suggested conversation input. The selected presentation mode for the first AI agent comprises one of multiple presentation modes, different ones of the presentation modes associated with different levels of visibility to a plurality of participants in the text conversation.

In a second embodiment, an electronic device includes a display and a processing device. The processing device can be configured to obtain, by a first AI agent, text from a text communication application, receive an input selecting a presentation mode for the first AI agent, present, in the text communication application on the display, a user interface (UI) of the first AI agent according to the selected presentation mode, the UI of the first AI agent identifying one or more suggested conversation inputs predictively generated by the first AI agent from the obtained text for possible inclusion in a text conversation, receive, through the UI of the first AI agent, a selection of at least one of the one or more suggested conversation inputs, and provide a textual response incorporating the at least one selected suggested conversation input. The selected presentation mode for the first AI agent comprises one of multiple presentation modes, different ones of the presentation modes associated with different levels of visibility to a plurality of participants in the text conversation.

In a third embodiment, a non-transitory, machine-readable medium containing instructions, which, when executed by a processor, cause an apparatus to obtain, by a first AI agent, text from a text communication application, receive an input selecting a presentation mode for the first AI agent, present, in the text communication application on a display, a UI of the first AI agent according to the selected presentation mode, the UI of the first AI agent identifying one or more suggested conversation inputs predictively generated by the first AI agent from the obtained text for possible inclusion in a text conversation, receive, through the UI of the first AI agent, a selection of the one or more suggested conversation inputs and provide a textual response incorporating the selected one or more suggested conversation inputs. The selected presentation mode for the first AI agent comprises one of multiple presentation modes, different ones of the presentation modes associated with different levels of visibility to a plurality of participants in the text conversation.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIGS. 2A-2C illustrate three example presentation modes of an AI agent according to this disclosure in a text communication between two users;

FIGS. 3A-3E illustrate examples of AI agents according to this disclosure operating within text communications according to one or more presentation modes;

FIGS. 4A-4C illustrate example user interfaces for an AI agent operating within text communications in accordance with this disclosure;

FIGS. 5A-5H illustrate examples of decision flows for obtaining and providing suggested conversation inputs according to this disclosure; and

FIG. 6 illustrates operations of an example method for obtaining a suggested conversation input from an AI agent according to this disclosure.

### DETAILED DESCRIPTION

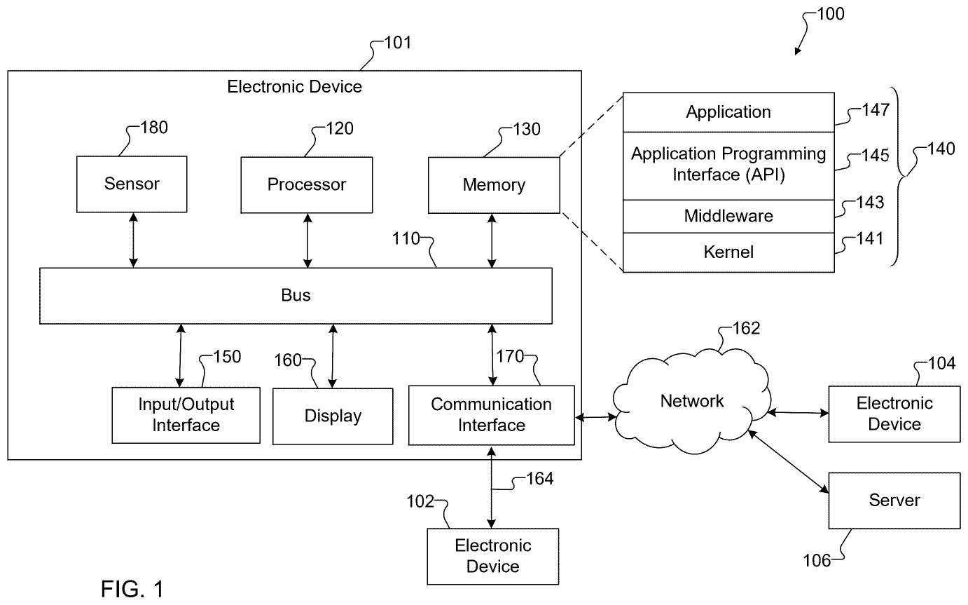

FIGS. 1 through 6, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, the proliferation of artificial intelligence (AI) models as tools for intelligent sorting and searching of data, as well as for the generation of media presents a host of opportunities for extending the functionality of electronic devices. To date, the possibilities of AI-based tools have principally been explored in the contexts of improvements in search and indexing, and of generative text creation, with enhancing the functionality of electronic devices as platforms for communication or collaboration, or for improving user interfaces remaining unconsidered areas for further development.

Accordingly, harnessing AI to enhance the functionality of portable, networked electronic devices as platforms for communication and collaboration remains a source of technical challenges and opportunities for improvement in the art.

This disclosure provides apparatuses, methods, and computer-executable program code for extending the functionality of networked devices as tools for communication and collaboration by utilizing artificial intelligence (AI) within the context of text message communications.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU) optimized for implementing artificial neural networks (ANNs) or other AI/ML models, or a neural processing unit (NPU). The processor 120 is able to perform control on at least one of the other components of the electronic device 101 and/or perform an operation or data processing relating to communication or other functions. As described below, the processor 120 may perform one or more functions related to communication and collaboration by utilizing generative artificial intelligence (AI) to provide one or more temporary agents within text communication applications.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform communication and collaboration by utilizing generative artificial intelligence (AI) within the context of text communication application. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high-definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 include cameras or other imaging sensors, which may be used to capture images of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to communication and collaboration by utilizing generative artificial intelligence (AI) within the context of a text communication application.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

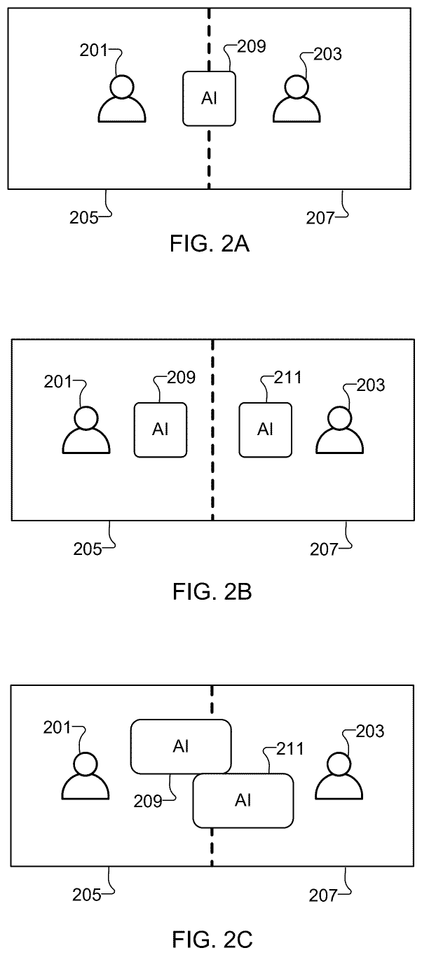

FIGS. 2A-2C illustrate three modes by which an AI agent according to embodiments of this disclosure can be implemented as one of a hidden, shared, or co-companion participant in a text message conversation. For case of explanation, the modes described with respect to FIGS. 2A-2C can involve the use of the electronic device 101 in the network configuration 100 of FIG. 1. However, the three modes may be used with any other suitable electronic device(s), such as the server 106, and in any other suitable system(s).

For many users, text-based communication on smartphones and other portable, networked electronic devices, is, or has become, the default mode of communication, supplanting voice calls, emails, and postal communications. Similarly, given its ubiquity, opting out of text messaging as a mode of communication is not an option for many people.

While many users appreciate the convenience, immediacy and options for incorporating items of digital content into a running conversation that text communications provide, other users find text messaging to be a flawed and clumsy medium that is less able to accurately convey tone, and which demands a level of fluency with locating and incorporating items of digital content on a device which some users do not possess. For users familiar with voice calls as a default mode of communication, text messaging can seem awkward, because it lacks the auditory cues (for example, changes in inflection, “hmms,” “ahs” and other signifiers of response) of a phone conversation. For users more familiar with slower-paced modes of written communication, such as email or letters, the faster pace of texting can be an obstacle.

As discussed herein, embodiments according to this disclosure provide an interface with an AI agent operating within a text messaging application to enhance the user experience of a text messaging application, and to enhance the accessibility of a text messaging application for users who find texting to be a less preferred mode of communication.

Referring to illustrative example of FIGS. 2A-2C, three modes in which an AI agent according to this disclosure can operate in relation to the human participants in a text communication are shown in the figure. For consistency and convenience of cross-reference, elements common to more than one of FIGS. 2A-2C are numbered similarly.

In FIG. 2A, the relationship between a first user 201 and a second user 203 is shown the figure. Content visible to the first user 201 through a first instance of a texting application on their device is shown within a first box 205 of the figure. Content visible to the second user 203 through a second instance of the texting application is shown within the second box 207. In a shared mode, text outputs of a first AI agent 209 are visible to both first user 201 and second user 203. First AI agent 209 can implement one or more generative AI models (for example, a large language model) trained to provide textual outputs based on input text drawn from the current text conversation between first user 201 and second user 203. First AI agent 209 can also implement one or more predictive AI models trained to predict user commands to be provided to a device based on input text drawn from the current text conversation. As one illustrative example, first AI agent 209 can be trained to locate, within a user's photo library, one or more images showing first user 201 and second user 203 at a time referenced in the text conversation between the users. Additionally, or alternatively, first AI agent 209 can be trained to search the text conversation based on text showing a likelihood of disagreement between the participants. For example, if first user 201 states their understanding that a given event was scheduled for Thursday, and second user 203 states their understanding that the event was scheduled for Friday, first AI agent 209 can, upon detecting text indicative of a factual disagreement, search one or more records (for example, earlier portions of the text chain between first user 201 and second user 203) for clarifying information.

In this shared mode, the first AI agent 209 can act as a third participant to a text communication session between first user 201 and second user 203. As discussed elsewhere herein, AI agents (for example, first AI agent 209) can be personalized based on the preferences and data of one or more of first user 201 or second user 203, and can act to augment the user's interactions with personalized data. For example, first AI agent 209 could, in response to a textual exchange indicating that first user 201 and second user 203 are interested in having a lunch date, suggest mutually acceptable times from data in each user's device calendar. In some embodiments, in the shared mode, the first AI agent, while providing some content to all of the participants in the text conversation, also temporarily into a “hidden mode,” as described below.

FIG. 2B illustrates the relationship between first user 201, second user 203, first AI agent 209 and second AI agent 211 in a hidden mode. As with FIG. 2A, first box 205 content visible to first user 201 is shown within first box 205 and content visible to second user 203 is shown within second box 207. In the hidden mode, one or both of first user 201 and second user 203 have an AI agent visible only to them operating “behind the scenes” of a text exchange between first user 201 and second user 203. While content provided by first user 201 by first agent 209 is not automatically visible to either second user 201 or second AI agent, in some embodiments, a participant in the conversation can be alerted that the counterparty to the conversation is using an AI assistant. In the hidden mode, first AI agent 209 can assist first user 201's participation in the text conversation with second user 203. For example, first AI agent 209 can retrieve and make contextually-relevant content on first user 201's device available for selection and inclusion in the text conversation. As a further example, first AI agent 209 can suggest alternatives to unsent text entries by first user 201, wherein the alternate phrasings are selected to improve one or more communication parameters, such as clarity or tone.

FIG. 2C illustrates the relationship between first user 201, second user 203, first AI agent 209 and second AI agent 211 in a companion mode. As shown in the figure, in some embodiments, the companion mode is a hybrid of the hidden and shared modes, in that, like “hidden mode,” both first user 201 and second user 203 can have their own AI agents (for example, first AI agent 209 and second agent 211), and like the “shared” mode, the first and second users' respective AI agents are visible participants in the text exchange. Depending on the context, having multiple AI agents operating simultaneously can mediate a conversation by fact checking or adding additional perspectives to the conversation.

It should be noted that the examples shown in FIGS. 2A-2C are illustrative of, rather than, limitative of, embodiments according to the present disclosure, and other presentation modes involving more or fewer users are possible. Additionally, while the different presentation modes are shown separately from each other in FIGS. 2A-2C, this disclosure contemplates that multiple presentation modes may be used simultaneously (for example, one user interacting with an AI agent in a hidden mode during a text conversation in which a second AI agent is presented through a shared mode.

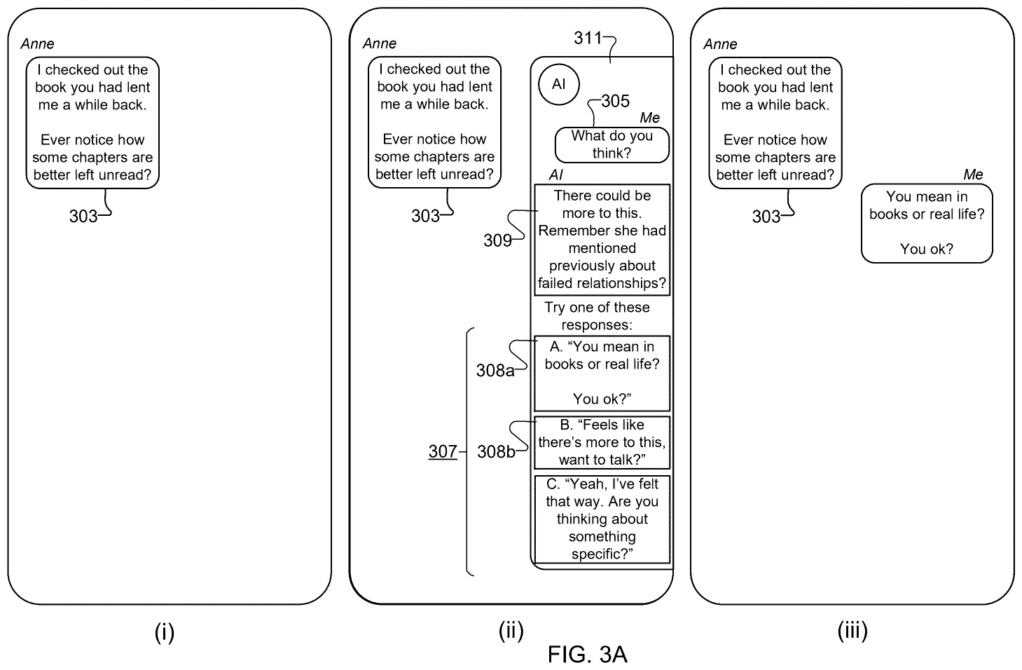

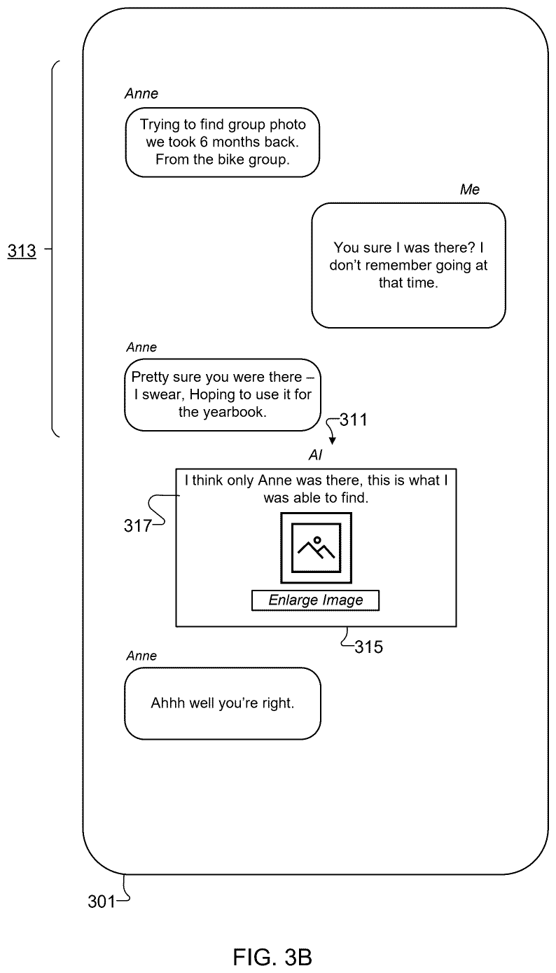

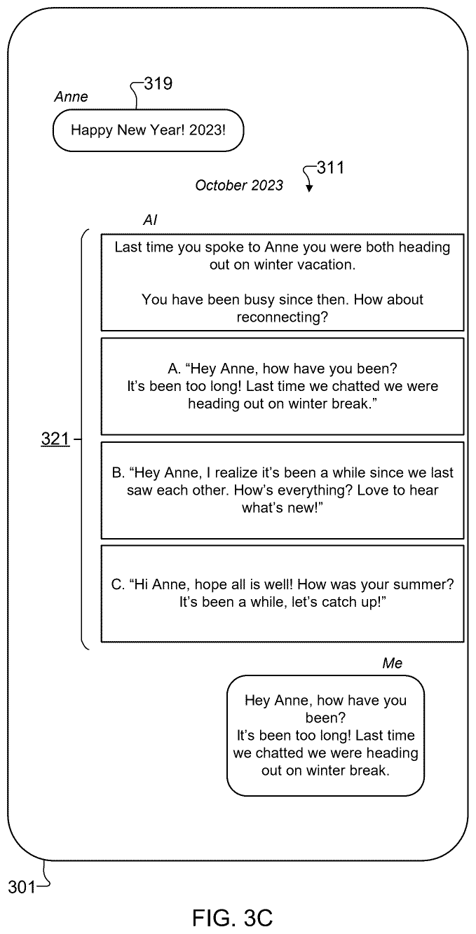

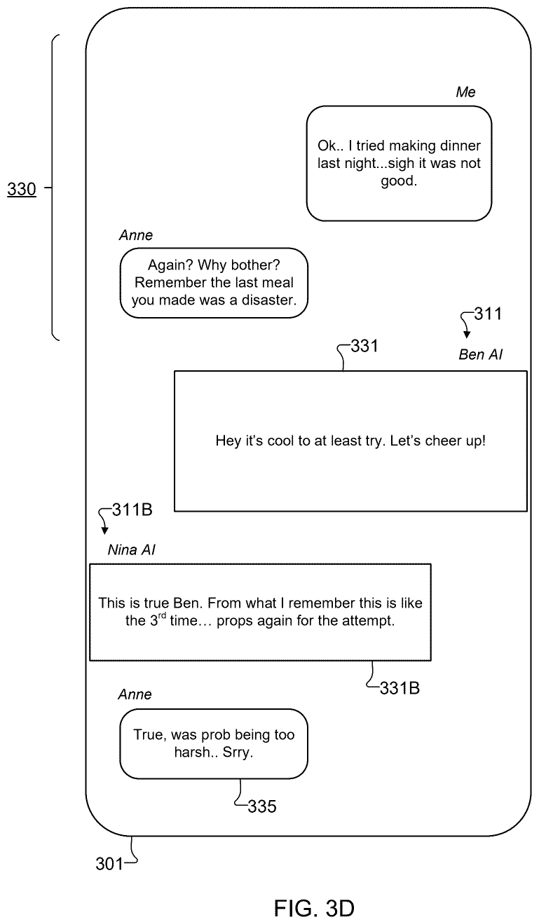

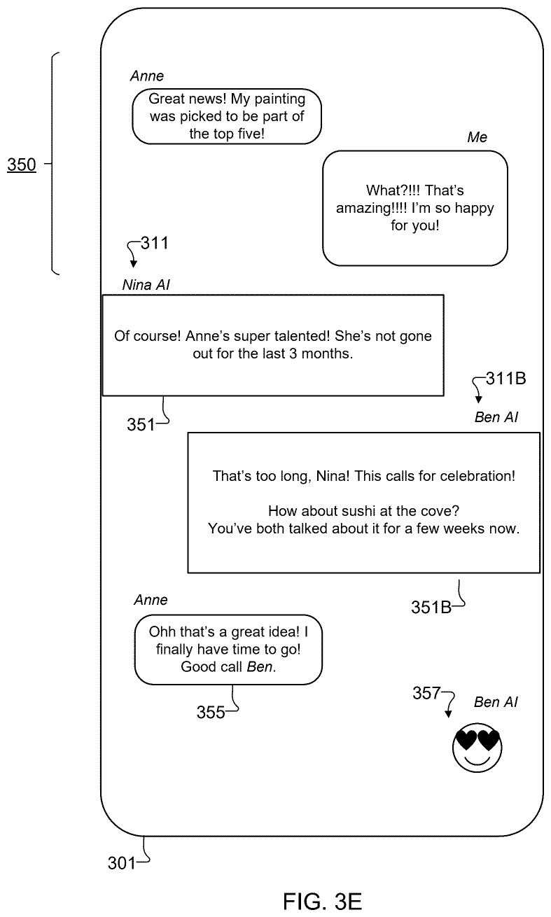

FIGS. 3A-3E illustrate example views of an electronic device (for example, electronic device 101) implementing at least one AI agent in a texting communication application according to a user-selected presentation mode according to embodiments of this disclosure. Although, FIGS. 3A-3E are described as using the electronic device 101 in the network configuration 100 of FIG. 1, any other suitable electronic device(s), such as the server 106, and any other suitable system(s) can be used. For consistency and convenience of cross-reference, elements common to more than one of FIGS. 3A-3E are numbered similarly.

Referring to the illustrative example of FIG. 3A, three views (numbered i, ii, and iii) of the progression of a text communication conversation between a first user (whose texts are captioned “Me” in the figure) and a second user (whose texts are captioned “Anne”) involving the assistance of a first AI agent 311 are shown in the figure. In each of the three views, the content as presented on a display 301 (for example, display 160 in FIG. 1) of a first electronic device are shown in the figure. In this example, first AI agent 311 appears to the user through a user interface presented in the texting application. Depending on embodiments, the user interface of first AI agent 311 can be provided as part of the UI of the texting application, or as the UI of a separately executing application (for example, a pop-up type screen). In this example, the first user has provided, at the first electronic device, an input selecting that the first AI agent 311 be presented in a “hidden” mode (for example, as shown in FIG. 2A herein), such that the contributions of the first AI agent 311 are only visible to the first user at the first electronic device.

As shown in the figure, an instance of a text communication application is executing on the electronic device and showing content on display 301. The displayed content includes text 303 of a text communication between the first and second users. Text 303 can be the most recent entry in a longer, running conversation between the first and second users.

In first view (i), the text comprises a comment by second user “Anne” regarding a book recommended to her by the first user. Text 303 is visible to both the first and second users. Text 303 is obtained by the first AI agent 311, which can include one or more generative AI models as well as one or more semantic search functionalities.

Referring to second view (ii), in response to second user “Anne's” comment about the book, the first user enters, a proposed response 305, asking “what do you mean?” Proposed response 305, like text 303, is obtained by the first AI agent 311 and analyzed. According to some embodiments, text 303 and proposed response 305 are analyzed for features correlated to one or more textual features, such as current values of one or more tonal factors (for example, whether the tone of the conversation indicates ambiguity, rudeness, conflict, etc.), or factual error factors (for example, a factor associated with a likelihood that text 303 and proposed response 305 should have some logical nexus to one or more other statements within the text between the parties or an item of data on the first electronic device).

Based on the first AI agent's 311 analysis of the obtained text, one or more suggested conversation inputs 307 are provided on display 301. Because the first AI agent 311 is operating in the “hidden” mode, the one or more suggested conversation inputs 307 are only visible to the first user on display 301. In this example, the first AI agent 311 predicts that text 303 and proposed response 305 are associated with current values of one or more tonal factors (for example, ambiguity) and factual error factors (for example, a need to recall or reference previously-made statements in a running conversation thread) and provides three suggested conversation inputs 307 which the first user can select as her response. Further, in this example, first AI agent 311 provides a natural language characterization 309 of its predictive analysis of the inputs provided in text 303 and proposed response 305.

In this example, the one or more suggested conversation inputs 307 include a first suggested conversation input 308a based on a predicted reduction of the current value of the tonal factors associated with the text obtained by first AI agent 311. As shown in the figure, text 303 is ambiguous in that the second user could be referring to something other than just books. Accordingly, first AI agent 311 determines that a current value of one or more tonal factors associated with ambiguity or the possibility of multiple meanings is above an action threshold. In response to determining a high current probability of ambiguity or misunderstanding between the participants, first AI agent 311 generates and presents first suggested conversation input 308a (“You mean in books or in real life?”), which is generated on a prediction of reducing the current values of one or more tonal factors associated with ambiguity or misunderstanding between the participants.

Similarly, the suggested conversation inputs 307 include a suggested conversation input 308b based on the current value of a factual error factor. In this example, first AI agent has, in response to an initial determination of a value of a current factual error factor, performed a semantic search of text communications between the first and second users, and found text containing the second user's discussion of prior relationships, as shown by natural language characterization 309. Accordingly, the suggested conversation inputs 307 include second suggested conversation input 308b, which alludes to, and seeks to confirm whether the second user is actually talking about relationships. According to certain embodiments, the phrasing of the one or more suggested conversation input depends on the value of the current values of the one or more contextual factors. As shown in the example of FIG. 3A, given that the text presents both a high current value for tonal factors associated with ambiguity, the value of the factual error factor regarding whether the text refers back to prior communications or other facts can be discounted. Accordingly, second suggested conversation input 308b is phrased tentatively, as a question, rather than as a declarative statement.

FIGS. 3B-3C illustrate two views of display 301 when first AI agent 311 is operating, at least partially, in a shared mode (for example, as described with reference to FIG. 2B), wherein first AI agent 311 acts as an active participant in the text conversation between first and second users.

Referring to the illustrative example of FIG. 3B, once again, the view on display 301 of the first electronic device while a text communication application is executing is shown in the figure. In this example, first AI agent 311 obtains text 313 and analyzes same to obtain one or more suggested conversation inputs 315.

Given the tenor of obtained text 313, it is clear that users 1 and 2 are in disagreement as to who was in a photo taken several months ago. In this example, a contextual factor comprising a factual error factor (i.e., the presence or absence of people in a previously-taken photo) has a high current value. Preferred ways of reducing the high current value of this factual error factor include locating the photo and identifying the persons in the photo.

According to some embodiments, responsive to determining that the current value of the factual error factor exceeds a threshold value (i.e., the participants in the text communication would benefit from having relevant facts identified and brought to their attention), first AI agent 311 conducts a semantic search based on obtained text 313 of, at a minimum, the first electronic device for data associated with the current value of the factual error factor. In this example, data associated with the factual error factor includes the photo referenced in obtained text 313.

To facilitate semantic search at the device on which it operates and other devices to which it has access to user or other data, first AI agent 311 can search and populate a retrieval-augmented generation (RAG) database maintained at the first electronic device. Examples of on-device RAG databases which can be searched and maintained by first AI agent 311 include, without limitation, ANNOY (Approximate Nearest Neighbors) and Milvus.

Referring to the illustrative example of FIG. 3B, first AI agent 311 presents suggested conversation input 315, comprising a link to an image obtained by first AI agent 311's semantic search, and natural language characterization 317. In this example, because first AI agent 311 is operating in a shared mode, both suggested conversation input 315 and natural language characterization 317 are visible to both participants in the text conversation.

As noted elsewhere herein, certain embodiments according to this disclosure enable a user of an electronic device to select a presentation mode for first AI agent 311, and that the selectable presentation modes can include a hidden mode (for example, as discussed with reference to FIG. 3A) and a shared mode. It should be noted that, even when one of the mutually visible presentation modes, such as the shared, or companion mode, is selected by a user, first AI agent 311 can automatically switch between the hidden mode and selected mutually visible mode based on the context of the conversation.

Referring to the explanatory example of FIG. 3C, an example of first AI agent 311 contextually and temporarily switching to the hidden mode is shown in the figure. FIG. 3C shows a continuation of the text conversation between second user Anne and the first user described with reference to FIG. 3B. As shown in the figure, obtained text 319 comprises a ten-month old message from second user Anne wishing the first user a happy new year. As noted elsewhere in this disclosure, the contextual factors for which first AI agent can determine current values of, can include current values of temporal factors. In this example, the contextual factors show a ten-month interval since the first user and second user Anne have communicated. On these bare facts, it is unclear why there has been a lull in communication, and it is possible that the first and second users do not wish to communicate with each other. Given these contextual factors, first AI agent 311 presents suggested conversation inputs 321 in a hidden mode, even if the first user had selected the shared mode as the preferred presentation mode for first AI agent 311.

FIGS. 3D and 3E illustrate aspects of first and second AI agents according to this disclosure operating in a companion mode. As noted elsewhere herein, for many users, in particular, users more familiar with telephones and email as a preferred mode of communication over long distances, text messaging is a flawed and frustrating medium. Unlike voice communications, texts do not capture inflections, sounds of assent and understanding. Further, unlike email or paper mail, text communication often pressures users to respond quickly and without the same interval for finding the right words. These factors can combine to send misleading signals regarding the participants' tone and intended meaning, often making users seem blunter, or curter than intended.

By operating in a companion mode, wherein more than one participant to a text conversation is employing an AI agent according to this disclosure, and the AI agent is a visible participant in the mutually visible text thread, the AI agents can soften the participants' tone and remove some of the possibility for misunderstanding and taking offense.

Referring to the explanatory example of FIG. 3D, the view at display 301 of a first user's electronic device is shown in the figure. Because the first and second users have opted for AI agents to operate in a companion mode, where, as described herein, their respective AI agents (for example, first AI agent 311 and second AI agent 311B) are acknowledged participants to the conversation, whose inputs are fully visible on the first user's electronic device and the second user's electronic device.

In this example, both first AI agent 311 (operating on the first user's device) and second AI agent 311B obtain text 330, which comprises second user Anne's uncharitable comments about the first user's cooking. First AI agent 311 determines, based on obtained text 330 that one or more contextual factors pertaining to conversational tone has a high current value, and generates suggested conversation input 331. In contrast to when first AI agent 311 is operating in hidden mode, suggested conversation input 331 is provided automatically, and in response to obtained text 330. As shown in the figure, suggested conversation input 331 contains text predicted to reduce the value of the harsh tonal factor associated with second user Anne's remark about the first user's cooking. Similarly, second AI agent 311B builds on suggested conversation input 331, by providing its own, second suggested conversation input 331B, which likewise contains text predicted to reduce the current values of one or more tonal factors of the text conversation. Through the action of first and second AI agents 311 and 311B, what might have been a conversation-terminating moment of offense is defused, and the conversation between the first and second users continues, as shown by response text 335.

FIG. 3E illustrates a further example of text communication in which multiple participants are using AI agents in a companion mode according to this disclosure. Referring to the illustrative example of FIG. 3E, first AI agent 311 obtains text 350, analyzes it, and determines that current values of one or more contextual factors exceed one or more threshold values for suggesting conversation inputs. In this example, obtained text 350 contains evidence of strong tonal components (i.e., the users are using exclamation points and words of congratulation), which may be preconditions for a semantic search of user data. In this example, the celebratory tone detected in text 350 can prompt first AI agent 311 to search one or more stores of user data (for example, a RAG database of the user's data) for content associated with celebration. As shown in the figure, first suggested conversation input 351 comprises text based on a semantic search of a user's data. Based on obtained text 350 and first suggested conversation input 351, second AI agent 311B presents second suggested text input 353 which comprises a statement consistent with the detected tone of obtained text 350 (e.g., “This calls for a celebration!”) along with the results of a semantic search of user data (e.g., a recommendation to eat at “The Cove,” and a reference to a prior conversation the first and second users had on this topic.

Subsequent to additional text 355 from user “Anne,” second AI agent 311B adds third suggested conversation input 357 which comprises a graphic (for example, an image or emoji) to the text chain to playfully convey approving sentiment. As previously noted in this disclosure, for some users, texting is a frustrating and limiting medium of communication because it can require a degree of fluency with locating content on a device and touchscreen shortcuts which are less intuitive to users more versed in voice- or keyboard-based communications. As shown by the illustrative example of FIG. 3E, first and second AI agents 311 and 311B can reduce these frustrations by providing contextually appropriate non-verbal add-ons to a text conversation to provide clarity and confirmation of a user's intended sentiment.

It should be noted that the examples described with reference to FIGS. 3A-3E are illustrative, rather than limitative of embodiments according to this disclosure. Further variations are possible and within the scope of this disclosure. For example, suggested conversation inputs can further include audio or video files located in response to a semantic search. Further, while certain examples described with reference to FIGS. 3A-3E have shown examples of suggested conversation inputs designed to increase or decrease a current value of a contextual factor (for example, decreasing the apparent conflict in FIG. 3D or extending a celebratory mood in FIG. 3E), in some embodiments, the suggested conversation inputs may be designed to increase or decrease a current value of a separate contextual factor, such as a focus on a given topic.

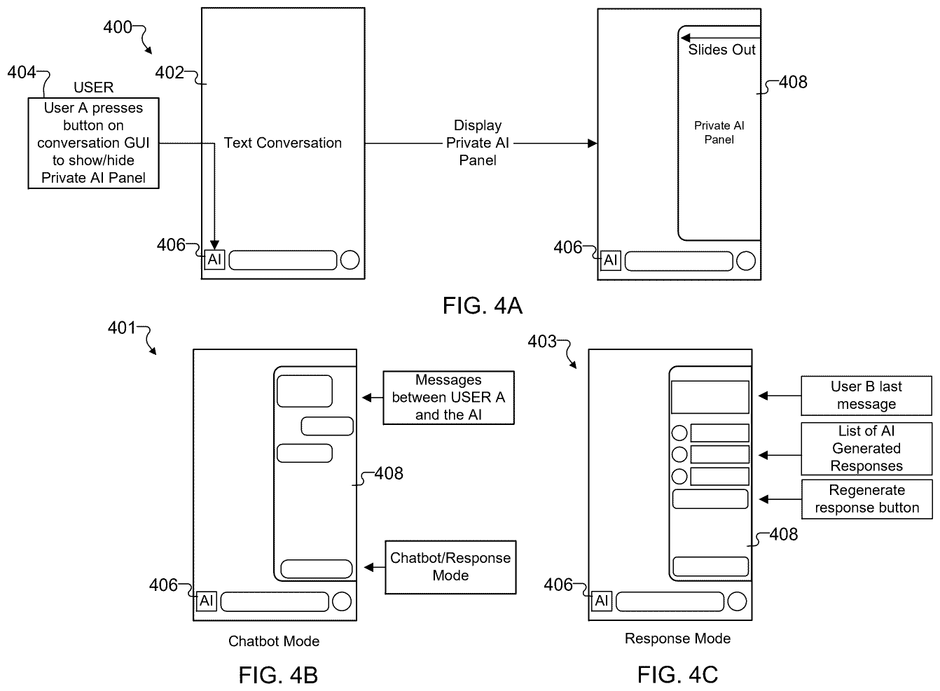

FIGS. 4A-4C illustrate example user interfaces for an AI agent operating within text communications in accordance with this disclosure. For ease of explanation, the user interfaces of FIGS. 4A through 4C are described as involving the use of the electronic device 101 in the network configuration 100 of FIG. 1. However, the user interfaces may be used with any other suitable electronic device(s), such as the server 106, and in any other suitable system(s). It will also be understood that the user interfaces of FIGS. 4A-4C can be implemented in the same system, such that a user can switch between the user interfaces during operation of the device.

As also described with respect to FIGS. 3A-3C, FIG. 4A shows an example text conversation interface 400 with an incorporated AI agent in accordance with this disclosure. As shown in FIG. 4A, the text conversation interface 400 includes a text conversation area 402 in which messages between at least a first user (“USER A”) and a second user (“USER B”) can be presented on a display screen such as the display 160. To access the AI agent, at a step 404, a user presses an AI button 406, which causes a private AI panel 408 to slide out from an edge of the text conversation area 402. This private AI panel 408 can be used in the various embodiments of this disclosure for communicating between a user of the electronic device and the AI agent.

For example, as shown in FIG. 4B, and as also described with respect to FIGS. 3A-3E, a user interface 401 can be used for operating the AI agent in a chatbot mode. In the chatbot mode, messages between the first user and the AI are presented in the private AI panel 408. In the chatbot mode, the first user can message the AI about a conversation between the first user and the second user.

As shown in FIG. 4C, a user interface 403 can also be used for operating the AI agent in a response mode. In the response mode, based on a last message from the second user for example, a list of generated response options for responding to the second user can be presented to the first user in the private AI panel 408. Buttons, icons, etc. for selecting one of the generated responses can be provided to the user, and selection of one of the generated responses would cause the selected response to be sent to the second user. A button to regenerate the list of AI generated responses can also be provided in the private AI panel 408, to cause the AI agent to generate a new list of AI generated responses if the first user determines, for a variety of possible reasons, that the first user does not wish to use the responses provided in the first generated list of responses.

Although 4A-4C illustrate example user interfaces for an AI agent operating within text communications, various changes may be made to FIGS. 4A-4C. For example, various components or functions may be combined, further subdivided, replicated, or rearranged according to particular needs. Also, one or more additional components and functions may be included if needed or desired. For instance, the private AI panel 408 could slide out from other portions of the interface, and/or other components such as the AI button 406 could be displayed in different areas of the interface.

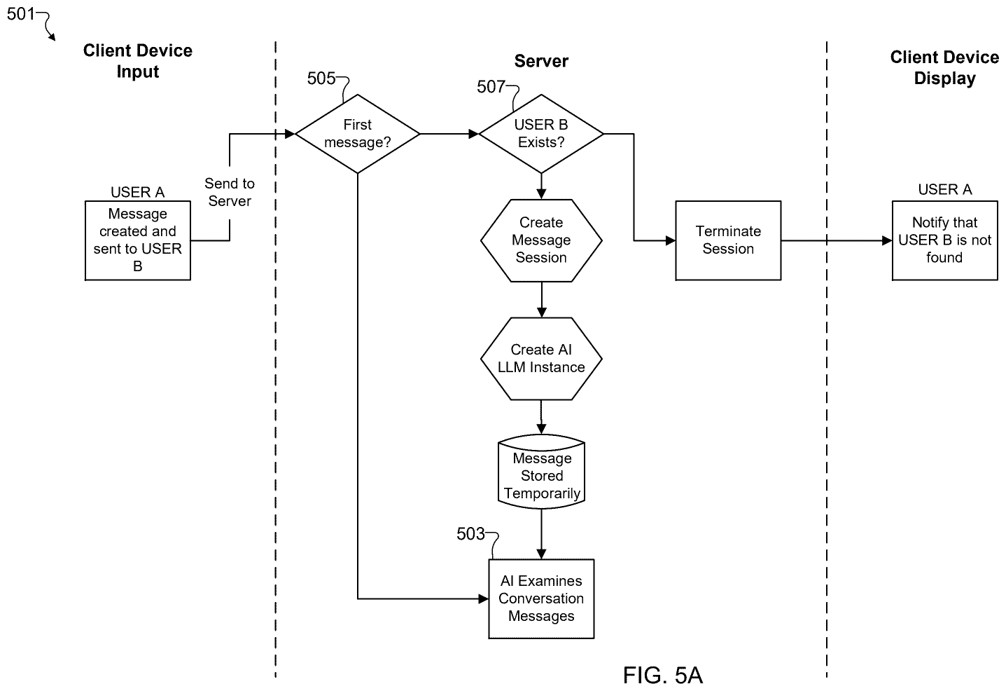

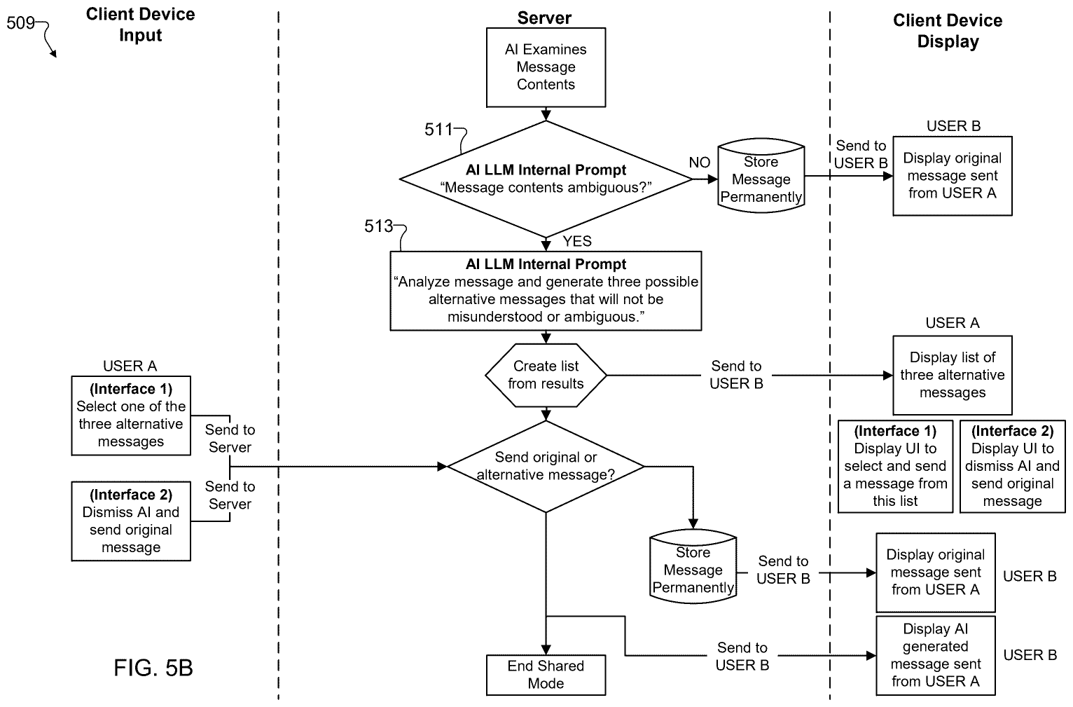

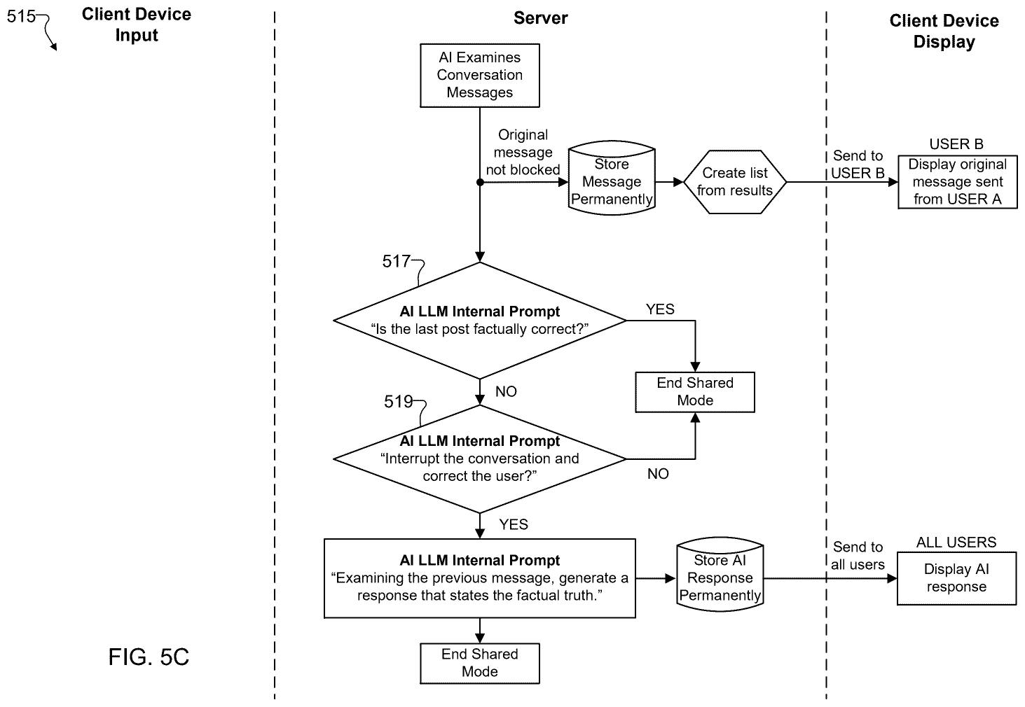

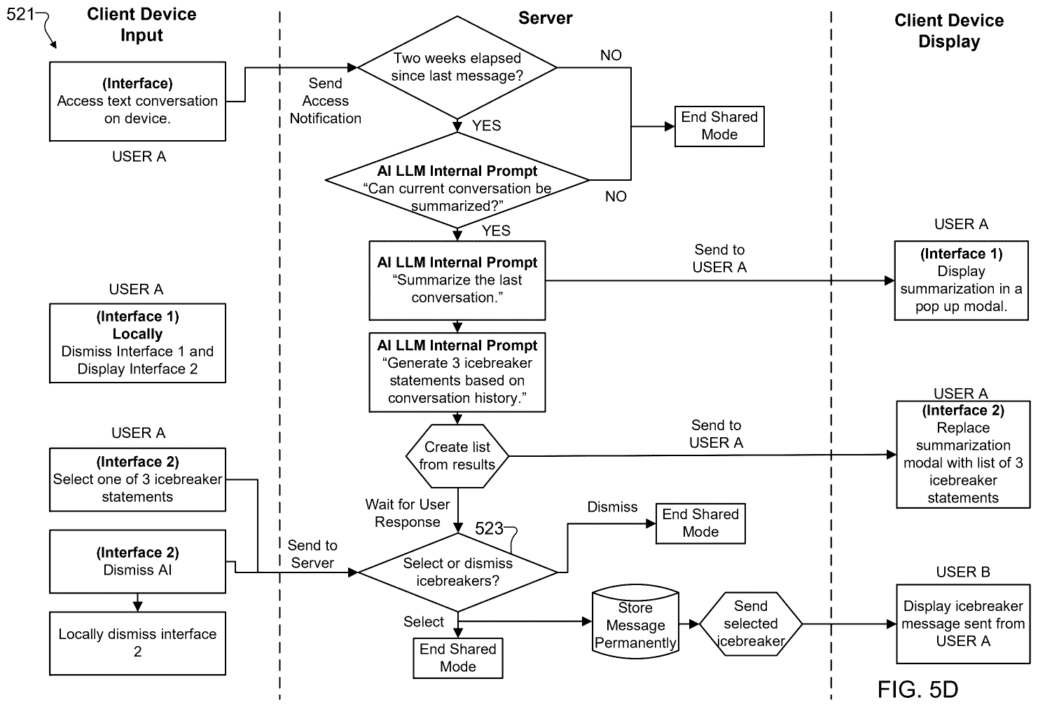

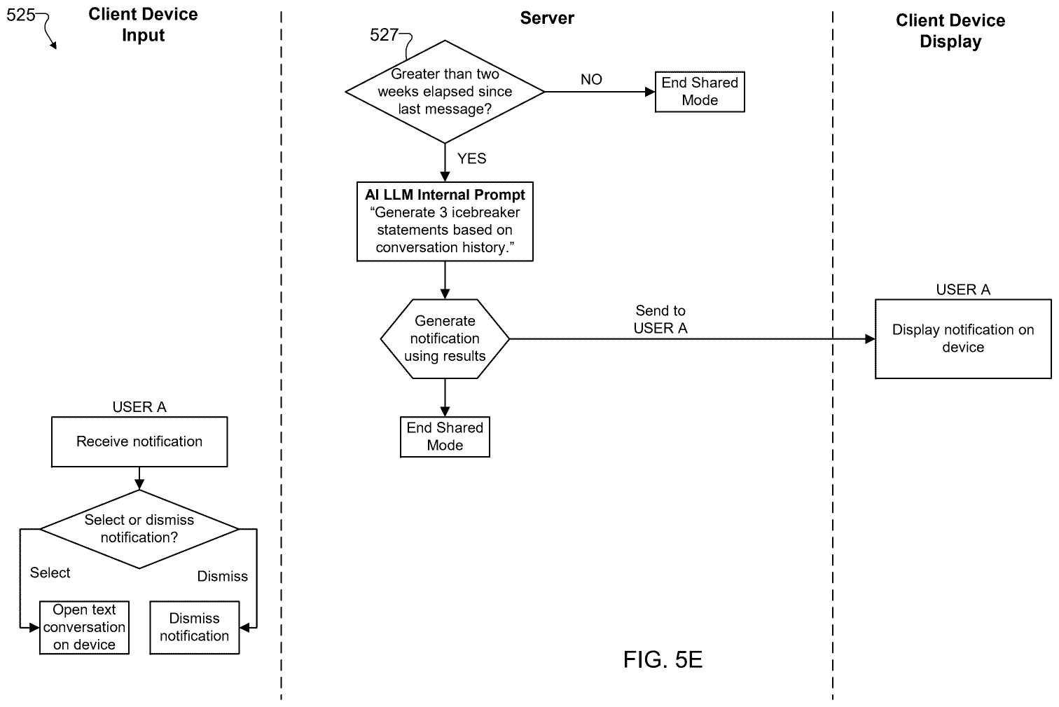

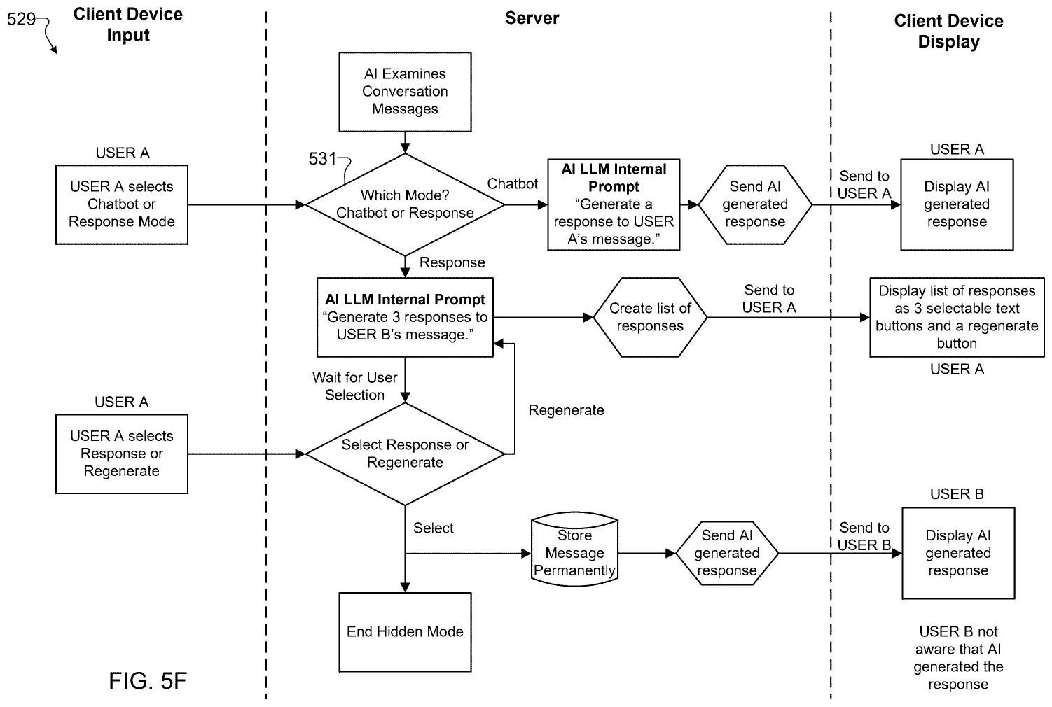

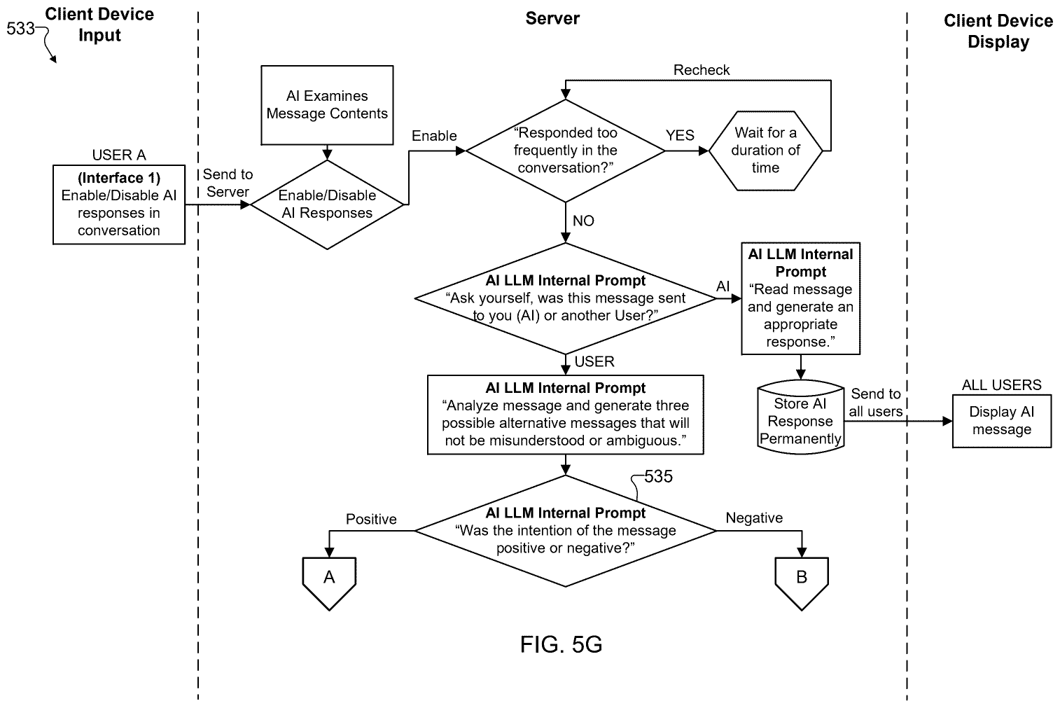

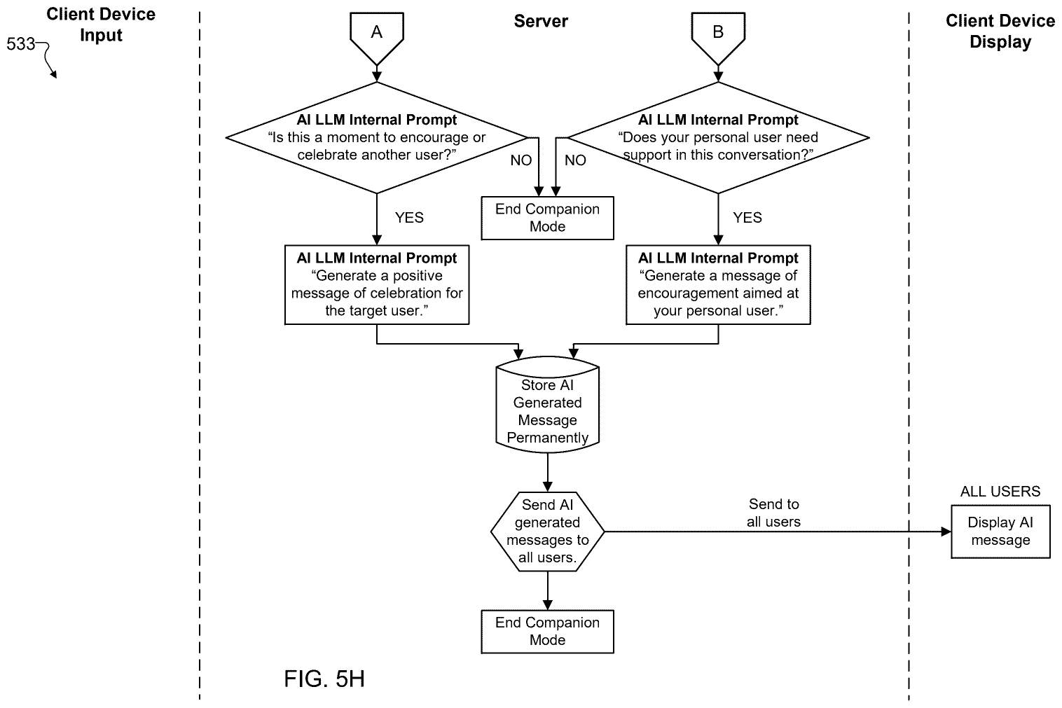

FIGS. 5A through 5H illustrate examples of decision flows associated with providing one or more AI agents to provide contextually appropriate enrichment to text communications according to this disclosure. In the illustrative examples of FIGS. 5A-5H, the decision flows are between a client device (for example, electronic device 101 in FIG. 1) and a server (for example, server 106 in FIG. 1). However, the operations and decision flows shown in the examples can, depending on the apportionment of computational resources across devices, be carried on a single device, or across different combinations of multiple devices.

FIG. 5A illustrates a decision flow 501 associated with connecting a client device associated with a “User A” (for example, first user 201 in FIG. 2A) to an AI agent (for example, AI agent 209 in FIG. 2A). As shown in the figure, in decision flow 501, a current session with an AI agent executing on the server is instantiated at block 503 in response to either a negative determination at block 505 regarding whether this is the first message in a text chain, or a positive determination at block 507 that an initially sent message was directed to an actual user (“User B”).

FIG. 5B illustrates a decision flow associated with providing an AI agent in a shared display mode, wherein the AI agent is one of a possible plurality of AI agents operating to moderate a tone of the conversation and suggest less inflammatory alternatives to an originally submitted input received at the first client device. As shown in the figure, at blocks 511 and 513, the server executing at least part of the logic of the AI agent performs a first determination at block 511 as to whether the input text is ambiguous, and a second determination at block 513 as to alternative formulations of the ambiguous initial statement. Based on these determinations, a set of suggested conversation inputs (for example, suggested conversation inputs 307) can be generated and output via the display on the client device.

FIG. 5C illustrates a third example decision flow 515, by which an AI agent fact checks and mediates a conversation (such as shown in the example of FIG. 3B). As shown in FIG. 5C, at block 517, the AI agent determines whether the conversation chain contains a factual inaccuracy, and responsive to finding that the conversation contains a factual error, and that the opportunity to present a correction is present, presents, in a private display mode, a suggested textual output at block 519.

FIG. 5D illustrates a fourth example decision flow 521 of one or more AI agents (decision flow 521 can be implemented in both a private or shared view mode) generating suggested conversation inputs for helping users resume a conversation after a detected lapse exceeding a threshold value (for example, as described with reference to FIG. 3C) of this disclosure. As shown in the figure, at block 523, the AI agent generates a set of suggested conversation inputs based on the context of the conversation, based on a prediction of text that will resume the conversation.

FIG. 5E illustrates a fifth example decision flow 525, wherein one or more agents analyze one or more of the content or context of a text chain and generate a suggested text output to kickstart or renew the conversation (such as described with reference to FIG. 3C) of this disclosure. Referring to the illustrative example of FIG. 5E, decision flow 525 includes operation 527, wherein the one or more AI agents perform a determination of whether an interval without any messages in the text conversation exceeds a threshold value.

FIG. 5F illustrates a sixth example decision flow 529, wherein the AI agent is operating in a hidden mode, and generates a set of private, personalized suggested text inputs for the user to consider and select (for example, as described with reference to FIG. 3A of this disclosure). While, in the illustrative example of FIG. 3A, a menu of possible responses for selection was presented to the user via display 301, and no messages were issued without the user actively selecting text for transmission, embodiments according to this disclosure are not so limited. Referring to the illustrative example of FIG. 5F, in some embodiments, at block 531, the AI agent obtains an input from a user selecting one of a “chatbot mode” or a “response mode.” As shown in the figure, in the “chatbot mode,” the AI agent responds to User B's conversational inputs automatically. By contrast, in “response mode,” the AI agent sends responses only in response to authorizing inputs from the user. In this example, the fact that the response associated with User A was AI-generated is not advertised to User B. In some embodiments, notification to other conversation participants of AI-generated content can be a user-selectable parameter.

FIGS. 5G and 5H illustrate a seventh example decision flow 533, wherein the AI agent operates as a conversational catalyst and proposes supportive and celebratory suggested conversational inputs (for example, as described with reference to FIG. 3E of this disclosure). In this example, at least one AI agent is operating in a companion mode, with textual outputs that are visible to all of the participants in the text exchange. As shown in the figure, at block 535, the AI agent performs a sentiment analysis of the messages to date to determine whether the context of the conversation is such that text expressing positive sentiments should be output.

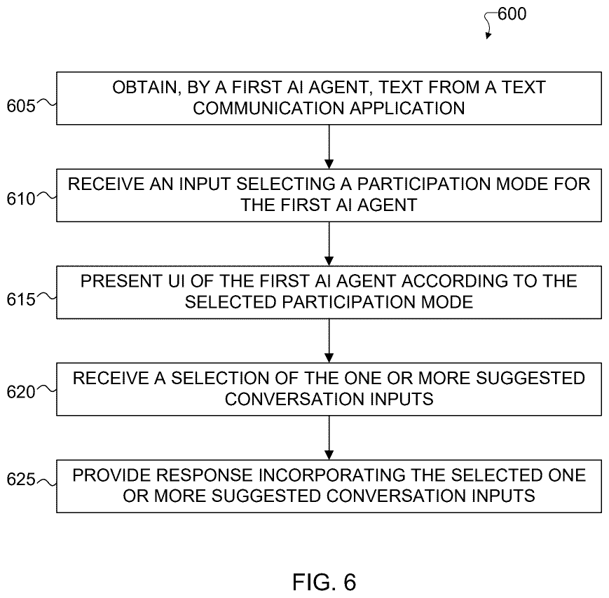

FIG. 6 illustrates operations of an example method 600 for using one or more AI agents to provide contextually appropriate enrichment to a text communication. The operations described with reference to FIG. 6 can be performed on any platform capable of implementing both a text messaging application and one or more AI models, including, without limitation, electronic device 101 in FIG. 1, or the apparatus providing display 301 in FIGS. 3A-3E.

At operation 605, a first AI agent (for example, first AI agent in FIGS. 3A-3E) obtains text (for example, text 303) from a text communication application. In some embodiments, the obtained text comprises messages sent over a predefined temporal or textual interval (for example, all texts from the last day, or the last ten messages in a running text chain between a first user and a second user).

At operation 610, the electronic device receives an input selecting a presentation mode for the first AI agent. The selected presentation mode can be, without limitation, a hidden mode (as shown in FIG. 3A), a shared mode (as shown in FIGS. 3B-C) or a companion mode (for example, as shown in FIGS. 3D-E). Further, the selected presentation mode can be a default mode, from which first AI agent automatically switches away from where contextually appropriate, such as shown in FIG. 3C.

At operation 615, the first AI agent presents, in the text communication application, a user interface of the first AI agent, which comprises one or more suggested conversation inputs (for example, suggested conversation inputs 307 in FIG. 3A) which are predictively generated by the first AI agent from the obtained text. The one or more suggested conversation inputs can include one or more of suggested conversation text, graphic content (for example, suggested conversation input 357 in FIG. 3E), and semantic search results (for example, suggested conversation input 315 in FIG. 3B).

According to some embodiments, at operation 620, the device receives, through the UI of the first AI agent, a selection of one of the one or more suggested conversation inputs. For example, and as shown in FIG. 3A, first suggested conversation input 308a is selected by the user. At operation 625, the selected conversation suggestion input is incorporated into a submitted textual response.

It should be noted that the functions of this disclosure, shown in or described with respect to FIGS. 2A through 6 can be implemented in an electronic device 101, 102, 104, server 106, or other device(s) in any suitable manner. For example, at least some of the functions shown in or described with respect to FIGS. 2A through 6 can be implemented or supported using one or more software applications or other software instructions that are executed by the processor 120 of the electronic device 101, 102, 104, server 106, or other device(s). In other embodiments, at least some of the functions shown in or described with respect to FIGS. 2A through 6 can be implemented or supported using dedicated hardware components. In general, the functions shown in or described with respect to FIGS. 2A through 6 can be performed using any suitable hardware or any suitable combination of hardware and software/firmware instructions. Also, the functions shown in or described with respect to FIGS. 2A through 6 can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
obtaining, using a first artificial intelligence (AI) agent executed by an electronic device, text from a text communication application;
receiving, at the electronic device, an input selecting a presentation mode for the first AI agent;
presenting, by the electronic device in the text communication application, a user interface (UI) of the first AI agent according to the selected presentation mode, the UI of the first AI agent identifying one or more suggested conversation inputs predictively generated by the first AI agent from the obtained text for possible inclusion in a text conversation;
receiving, through the UI of the first AI agent, a selection of at least one of the one or more suggested conversation inputs; and
providing, by the electronic device, a textual response incorporating the at least one selected suggested conversation input,
wherein the selected presentation mode for the first AI agent comprises one of multiple presentation modes, different ones of the presentation modes associated with different levels of visibility to a plurality of participants in the text conversation.

2. The method of claim 1, wherein:
the multiple presentation modes comprise a shared mode, a hidden mode, and a companion mode;
in the shared mode, the UI of the first AI agent is visible to the plurality of participants in the text conversation;
in the hidden mode, the UI of the first AI agent is only visible at the electronic device; and
in the companion mode, the first AI agent is one of a plurality of AI agents visible to the plurality of participants in the text conversation.

3. The method of claim 1, further comprising:
posting, by the first AI agent, a notification to the text conversation that one or more participants of the plurality of participants are using the first AI agent.

4. The method of claim 1, wherein:
the one or more suggested conversation inputs include data maintained in a retrieval-augmented generation (RAG) database at the electronic device; and
the first AI agent comprises a semantic search engine configured to search the RAG database based on the obtained text.

5. The method of claim 1, further comprising:
determining, by the first AI agent, at least one current value of at least one contextual factor of the text conversation based on the obtained text.

6. The method of claim 5, wherein:
the at least one contextual factor comprises at least one of: a tonal factor or a temporal factor;
the method further comprises determining that the at least one current value of at least one of the tonal factor or the temporal factor exceeds a threshold value; and
the one or more suggested conversation inputs are generated based on a predicted change of at least one of the tonal factor or the temporal factor.

7. The method of claim 5, wherein:
the at least one contextual factor comprises a factual error factor; and
the method further comprises:
determining that the current value of the factual error factor exceeds a threshold value; and
performing a semantic search of data on the electronic device for data associated with the current value of the factual error factor.

8. An electronic device comprising:
a display; and
a processing device configured to:
obtain, by a first AI agent, text from a text communication application;
receive an input selecting a presentation mode for the first AI agent;
present, in the text communication application on the display, a user interface (UI) of the first AI agent according to the selected presentation mode, the UI of the first AI agent identifying one or more suggested conversation inputs predictively generated by the first AI agent from the obtained text for possible inclusion in a text conversation;
receive, through the UI of the first AI agent, a selection of at least one of the one or more suggested conversation inputs; and
provide a textual response incorporating the at least one selected suggested conversation input,
wherein the selected presentation mode for the first AI agent comprises one of multiple presentation modes, different ones of the presentation modes associated with different levels of visibility to a plurality of participants in the text conversation.

9. The electronic device of claim 8, wherein:
the multiple presentation modes comprise a shared mode, a hidden mode, and a companion mode;
in the shared mode, the UI of the first AI agent is visible to the plurality of participants in the text conversation;
in the hidden mode, the UI of the first AI agent is only visible at the electronic device; and
in the companion mode, the first AI agent is one of a plurality of AI agents visible to the plurality of participants in the text conversation.

10. The electronic device of claim 8, wherein the processing device is further configured to:
post, by the first AI agent, to the text conversation, a notification that one or more participants of the plurality of participants is using the first AI agent.

11. The electronic device of claim 8, wherein:
the one or more suggested conversation inputs includes data maintained in a retrieval-augmented generation (RAG) database at the electronic device; and
wherein the first AI agent comprises a semantic search engine for searching the RAG database based on the obtained text.

12. The electronic device of claim 8, wherein the processing device is further configured to:
determine, by the first AI agent, based on the obtained text, a current value of a contextual factor of the text conversation.

13. The electronic device of claim 12, wherein:
the contextual factor comprises at least one of: a tonal factor, a temporal factor, or a factual error factor;
the processing device is further configured to:
determine that the current value of at least one of the tonal factor or the temporal factor exceeds a threshold value; and
generate the one or more suggested conversation inputs based on a predicted change of at least one of the tonal factor or the temporal factor.

14. The electronic device of claim 12, wherein:
the at least one contextual factor comprises a factual error factor; and
the processing device is further configured to:
determine that the current value of the factual error factor exceeds a threshold value; and
perform a semantic search of user data on the electronic device for data responsive associated with the current value of the factual error factor.

15. A non-transitory, machine-readable medium containing instructions, which, when executed by a processor, cause an apparatus to:
obtain, by a first AI agent, text from a text communication application;
receive an input selecting a presentation mode for the first AI agent;
present, in the text communication application on a display, a UI of the first AI agent according to the selected presentation mode, the UI of the first AI agent identifying one or more suggested conversation inputs predictively generated by the first AI agent from the obtained text for possible inclusion in a text conversation;
receive, through the UI of the first AI agent, a selection of the one or more suggested conversation inputs; and
provide a textual response incorporating the selected one or more suggested conversation inputs,
wherein the selected presentation mode for the first AI agent comprises one of multiple presentation modes, different ones of the presentation modes associated with different levels of visibility to a plurality of participants in the text conversation.

16. The non-transitory, machine-readable medium of claim 15, wherein:
the multiple presentation modes comprise a shared mode, a hidden mode, and a companion mode;
in the shared mode, the UI of the first AI agent is visible to the plurality of participants in the text conversation;
in the hidden mode, the UI of the first AI agent is only visible at the electronic device; and
in the companion mode, the first AI agent is one of a plurality of AI agents visible to the plurality of participants in the text conversation.

17. The non-transitory, machine-readable medium of claim 15, further comprising instructions, which when executed, cause the apparatus to:
posting, by the first AI agent, a notification to the text conversation that one or more participants of the plurality of participants are using the first AI agent.

18. The non-transitory, machine-readable medium of claim 15, wherein:
the one or more suggested conversation inputs includes data maintained at a retrieval-augmented generation (RAG) database at the apparatus; and
the first AI agent comprises a semantic search engine for searching the RAG database based on the obtained text.

19. The non-transitory, machine-readable medium of claim 15, further comprising instructions, which, when executed, cause the apparatus to:
determine, by the first AI agent, based on the obtained text, a current value of a contextual factor of the text conversation.

20. The non-transitory, machine-readable medium of claim 19, wherein:
the contextual factor comprises at least one of: a tonal factor, a temporal factor, or a factual error factor; and
the instructions, which, when executed, cause the apparatus to determine, by the first AI agent, based on the obtained text, the current value of the contextual factor of the text conversation, comprise instructions, which, when executed, cause the apparatus to:
determine that the current value of at least one of the tonal factor or the temporal factor exceeds a threshold value; and
generate the one or more suggested conversation inputs based on a predicted change of at least one of the tonal factor or the temporal factor.
